(19) United States
(12) Patent Application Publication
(10) Pub. No.: US 2016/0008851 A1
(43) Pub. Date: Jan. 14, 2016

(54) METHOD FOR MOLDING PIEZOELECTRIC POLYMER AND MOLDED BODY

(71) Applicant: A SCHOOL CORPORATION KANSAI UNIVERSITY, Suita-shi, Osaka (JP)

(72) Inventors: Yoshiro TAJITSU, Osaka (JP); Yasuyuki KARASAWA, Gunma (JP)

(73) Assignee: A SCHOOL CORPORATION KANSAI UNIVERSITY, Osaka (JP)

(21) Appl. No.: 14/649,447

(22) PCT Filed: Nov. 28, 2013
(86) PCT No.: PCT/JP2013/082031

§ 371 Date: Jun. 3, 2015

(30) Foreign Application Priority Data
Dec. 4, 2012 (JP) 2012-265151

(51) Int. Cl. B06B 1/06; B29C 43/56; C08G 63/08; H04R 17/00; H04R 31/00; H04R 7/12; B29C 43/52; B29C 43/02

(52) U.S. Cl. CPC B06B 1/0655; B29C 43/52; B29C 43/56; B29C 43/02; H04R 17/005; H04R 31/00; H04R 7/12; C08G 63/08; B29C 2043/561; B29K 2433/12; B29K 2067/046

(57) ABSTRACT

A method for molding capable of molding a piezoelectric polymer into polymer piezoelectric materials having various shapes is provided. A vibration generator using a polymer piezoelectric material and a speaker capable of generating a high sound pressure and achieving flat sound pressure-frequency characteristics are provided. A material formed from a piezoelectric polymer is molded at a temperature not less than the glass transition temperature and less than the crystallization temperature of the piezoelectric polymer and is then heat-treated at a temperature not less than the crystallization temperature of the piezoelectric polymer. A vibration generator comprising a piezoelectric portion formed from a piezoelectric polymer; a first electrode disposed on a first main surface of the piezoelectric portion; and a second electrode disposed on a second main surface of the piezoelectric portion, which has a piezoelectric modulus of 0.5 pC/N or more and satisfies at least one of the following (a) to (c):
(a) the ratio of the length in the longitudinal direction to the thickness of the piezoelectric portion is about 100 or more;
(b) the ratio of the curvature radius of a curved portion to the thickness of the piezoelectric portion is about 10 or more; and
(c) the ratio of the length in the longitudinal direction to the curvature radius of the curved portion of the piezoelectric portion is about 0.01 or more.

### TECHNICAL FIELD

The present invention relates to a method for molding a piezoelectric polymer and a molded body obtained by the method for molding. The present invention also relates to a vibration generator using a polymer piezoelectric material and a speaker provided with the vibration generator.

### BACKGROUND ART

While piezoelectric ceramics such as lead zirconate titanate (PZT) are conventionally widely used as piezoelectric materials, attention is recently increasingly focused on piezoelectric polymers such as polyvinylidene fluoride, polypeptide, and polylactic acid because of excellent workability, flexibility, transparency, lightness, etc. Among them, polylactic acid having helical chirality as disclosed in Patent Literature 1 is attracting attention as an ideal piezoelectric polymer material since the polylactic acid can achieve a relatively high piezoelectric property only with a stretching treatment without the need of a poling treatment and can maintain the piezoelectric modulus for a long period.

### PRIOR ART LITERATURE

### Patent Literature

Patent Literature 1: JP 5-152638 A

Patent Literature 2: JP 2003-244792 A

### SUMMARY OF THE INVENTION

### Problem to be Solved by the Invention

A polymer piezoelectric material formed from a piezoelectric polymer having helical chirality is generally obtained by performing a uniaxial stretching treatment of a film formed form a piezoelectric polymer to orientate the molecules of the piezoelectric polymer. However, the polymer piezoelectric material obtained by the uniaxial stretching treatment is a planar film and the application thereof is limited to those obtained by processing a film.

On the other hand, various molding methods such as vacuum molding are known as a method of forming a polymer such as a resin into a desired shape; however, when a usual molding method is applied to a piezoelectric polymer, a problem arises that molecules are not oriented and do not provide a favorable piezoelectric property.

Therefore, an object of the present invention is to provide a method for molding capable of molding a piezoelectric polymer into polymer piezoelectric materials having various shapes.

It is proposed to use the polymer piezoelectric material as described above as a diaphragm in a piezoelectric speaker. However, since polymer piezoelectric materials particularly made of a polymer having helical chirality such as polylactic acid have a shear piezoelectric property and therefore its vibration direction is the orientation direction of the piezoelectric polymer, i.e., the direction parallel to the diaphragm plane, it is a problem that the materials cannot strongly vibrate air and cannot provide a high sound pressure.

Methods of solving this problem conventionally include a method in which a metal plate is bonded to a piezoelectric film thereby converting a vibration parallel into a perpendicular vibration to a film plane or a method in which two piezoelectric films are bonded together to obtain a bimorph type. However, such methods require a step of bonding films, therefore, are disadvantageous in terms of manufacturing.

Alternatively, it is known that a piezoelectric film diaphragm is supported in a curved state to generate a breathing vibration in a direction perpendicular to a film plane (Patent Document 2). However, even such a configuration causes another problem that it is difficult to achieve flat sound pressure-frequency characteristics.

Therefore, another object of the present invention is to provide a speaker can be easily produced by a simple method and capable of generating a high sound pressure and achieving flat sound pressure-frequency characteristics.

### Means to Solve the Problem

As a result of intensive studies, the present inventors found that a piezoelectric polymer was molded at a certain temperature and then heat-treated at a certain temperature, thereby enabling both to provide a piezoelectric property to a molded body and mold into a desired shape.

In particular, according to a first aspect of the present invention, there is provided a method for molding a piezoelectric polymer, wherein a material formed from a piezoelectric polymer is molded at a temperature not less than the glass transition temperature and less than the crystallization temperature of the piezoelectric polymer and is then heat-treated at a temperature not less than the crystallization temperature of the piezoelectric polymer.

As a result of intensive studies, the present inventors also found that by setting a ratio of the length in a longitudinal direction to a thickness of a polymer piezoelectric material to about 10 or more, a vibration due to buckling can be generated in addition to piezoelectric vibration, and by using this as a diaphragm in a piezoelectric speaker, a high sound pressure can be generated and flat sound pressure-frequency characteristics can be achieved.

In particular, according to a second aspect of the present invention, there is provided a vibration generator comprising a piezoelectric portion formed from a piezoelectric polymer; a first electrode disposed on a first main surface of the piezoelectric portion; and a second electrode disposed on a second main surface of the piezoelectric portion, wherein the ratio of the length in the longitudinal direction to the thickness of the piezoelectric portion is about 10 or more.

According to a third aspect of the present invention, there is provided a speaker comprising the vibration generator as a diaphragm.

### Effect of the Invention

According to the method for molding of the present invention, a piezoelectric polymer can be molded into polymer piezoelectric materials having various shapes. According to the vibration generator of the present invention, a vibration due to buckling can be generated and this can be used as a diaphragm in a speaker, thereby generating a high sound pressure and achieving flat sound pressure-frequency characteristics.

### BRIEF DESCRIPTION OF DRAWINGS

FIG. 1 is a perspective view of a piezoelectric speaker in one embodiment of the present invention.

FIG. 2 is a perspective view of a body portion 8 of the speaker shown in FIG. 1.

FIG. 3 is a cross-sectional view of a side surface portion 4 shown in the speaker of FIG. 1 taken along a line A-A.

FIG. 4 is a graph of sound pressure-frequency characteristics of speakers of Example 3, Comparative Example 2, and Comparative Example 3.

### EMBODIMENTS TO CARRY OUT THE INVENTION

A method for molding a piezoelectric polymer of the present invention will now be described below.

In the present specification, a “piezoelectric polymer” means a polymer that is able to exhibit a piezoelectric property when molecules thereof are uniaxially oriented. A “polymer piezoelectric material” means a polymer material formed from the piezoelectric polymer and having a piezoelectric property.

According to a first aspect of the present invention provides a method for molding a piezoelectric polymer, wherein a material formed from a piezoelectric polymer is molded at a temperature not less than the glass transition temperature and less than the crystallization temperature of the piezoelectric polymer and is then heat-treated at a temperature not less than the crystallization temperature of the piezoelectric polymer.

The piezoelectric polymer used in the method for molding of the present invention is a piezoelectric polymer having helical chirality. The piezoelectric polymers having helical chirality include polymers having chirality and comprising a main chain drawing a spiral such as polylactic acid, polypeptide, polymethyl glutamate, and polybenzyl glutamate. Polylactic acid or copolymers containing lactic acid as a constituent unit is preferable, and polylactic acid is more preferable. The polylactic acid may be either L-isomer or D-isomer and is preferably easily available L-isomer polylactic acid.

The materials formed from a piezoelectric polymer subjected to the method for molding of the present invention are materials comprising a piezoelectric polymer as a main component and include, for example, a material containing a piezoelectric polymer content of 50% by mass or more, 60% by mass or more, 70% by mass or more, or 80% by mass or more, or a material substantially consisting of a piezoelectric polymer, for example, a material having a piezoelectric polymer content of 99 to 100% by mass.

The materials formed from a piezoelectric polymer subjected to the method for molding of the present invention preferably has a form of sheet or film, although it is not particularly limited as long as it is has a form capable of being subjected to various molding methods. The thickness of the sheet or film is not particularly limited but is, for example, about 1 μm to 20 mm, preferably about 0.03 to 1.0 mm, more preferably about 0.1 to 0.3 mm.

The weight average molecular weight of the piezoelectric polymer is not particularly limited but is, for example, in the case of lactic acid, preferably about 10,000 to 1,000,000, more preferably about 15,000 to 400,000, further preferably about 20,000 to 250,000. By setting the weight average molecular weight to about 10,000 or more, the mechanical strength and the elasticity of an obtained molded body (polymer piezoelectric material) can be ensured. By setting the weight average molecular weight to about 1,000,000 or less, orientation in crystallization can be more increased.

In the method for molding of the present invention, the temperature at the time of vacuum molding is a temperature not less than the glass transition temperature and less than the crystallization temperature of a piezoelectric polymer used. For example, when polylactic acid with the weight average molecular weight of 100,000 is used, the temperature range is about 50 to 105° C., preferably about 70 to 110° C., more preferably about 75 to 105° C. By setting the temperature to the glass transition temperature or more, the vacuum molding is facilitated and a film can be prevented from being damaged at the time of the vacuum molding. By setting the temperature to the crystallization temperature or less, the piezoelectric modulus of the obtained molded body can be stabilized.

The “glass transition temperature” can be measured by differential scanning calorimetry (DSC). The “crystallization temperature” can be measured by differential scanning calorimetry (DSC).

In the method for molding of the present invention, vacuum molding, pressure molding, injection molding, compression molding, blow molding, etc. can be utilized, preferably vacuum molding is used, but not particular limited thereto.

When the method for molding of the present invention is performed by vacuum molding, a material formed from a piezoelectric polymer set in a (metal) mold (including female and male molds regardless of material thereof; hereinafter collectively referred to simply as a “metal mold”) may be pressed (pushed in) with a plug from a plane opposite to the metal mold toward the inside of the metal mold to assist the vacuum molding. The pressure at the time of pressing is a pressure of about 140 to 20,000 kg, preferably about 200 to 5,000 kg, more preferably about 300 to 2,000 kg per 1 cm² press area. By setting the press pressure within the range, a high piezoelectric modulus can be acquired.

In the method of the present invention, “vacuum” means a pressure that can be achieved by using a common vacuum pump and is specifically a pressure not more than 1×10⁻³ Pa.

In the method for molding of the present invention, stretching is preferably performed at a stretch ratio at which desired retardation described below is achieved.

The method for molding of the present invention includes heat treatment of an obtained molded body after vacuum molding. The temperature of the heat treatment is not particularly limited as long as the temperature is not less than the crystallization temperature and not more than the melting point or the decomposition temperature of the piezoelectric polymer used, but is preferably a temperature about 0 to 50° C. higher than the crystallization temperature, more preferably a temperature about 3 to 20° C. higher than the crystallization temperature. For example, when the piezoelectric polymer is polylactic acid, the temperature range is about 80 to 150° C., preferably about 100 to 110° C. By performing the heat treatment within the temperature range, crystals with favorable orientation of piezoelectric polymer molecules can be formed to achieve a higher piezoelectric modulus.

The “melting point” can be measured by differential scanning calorimetry (DSC).

The heat treatment can be performed at any timing after vacuum molding. For example, the molded body may be heated before taking out from the metal mold after vacuum molding. Alternatively, after vacuum molding, the molded body may be taken out from the metal mold and heat-treated by using another heating means such as a heating furnace.

After the heat treatment, preferably, the heated molded body is rapidly cooled to a temperature not more than the glass transition temperature. By rapidly cooling, the generation of spherocrystals adversely affecting a piezoelectric property can be suppressed.

The materials formed from a piezoelectric polymer used in the method for molding of the present invention may contain a softening agent. By using the additive, the flexibility of the film is increased and the vacuum molding is facilitated.

Although the softening agent is not particularly limited, when the piezoelectric polymer is polylactic acid, the softening agent is preferably an elastomer having affinity for or reactivity with a carboxylic acid group or a hydroxyl group at the polymer end. Such elastomers include styrene elastomers to which a functional group having excellent affinity for a carboxylic acid group or a hydroxyl group, for example, amine, epoxy, or anhydrous carboxylic acid is added (e.g., SBS or SEBS obtained by hydrogenating SBS), olefin elastomers to which the same functional group is added, and polyhydroxybutyrate soft copolymers (styrene elastomers having an amine terminal). Specifically, such elastomers include block copolymers of polyalkyl methacrylate and polyalkyl acrylate, for example, PMMA-PnBA-PMMA (polymethylmethacrylate-poly(n-butyl acrylate)-polymethylmethacrylate) block copolymers. The block copolymers are available as, for example, LA2250 (trade name), LA2140 (trade name), and LA4285 (trade name) manufactured by Kuraray Co., Ltd.

An addition amount of the softening agent is about 1 to 40% by mass, preferably about 5 to 30% by mass with respect to the total amount of the piezoelectric polymer and the softening agent. By setting the addition amount to about 1% by mass or more, the vacuum molding is facilitated. By setting the addition amount to 40% by mass or less, the decreasing of the elastic modulus and the piezoelectric modulus of the obtained molded body can be suppressed.

The materials formed from a piezoelectric polymer used in the method for molding of the present invention may include other additives, for example, a coloring agent and a plasticizing agent.

The molded body obtained from the method for molding of the present invention has a piezoelectric portion. The piezoelectric portion preferably has retardation of 100 nm or more, more preferably 500 nm or more, further preferably 1,000 nm or more.

The shape of the molded body obtained from the method for molding of the present invention is not particularly limited as long as the shape may be achieved by vacuum molding, and may be, for example, a circular cylinder, a circular cone, polygonal columns such as a triangular prism and a quadrangular prism, polygonal pyramids such as a triangular pyramid and a quadrangular pyramid, a dome shape, and an arbitrary combination thereof, and the shape is preferably a shape in which the piezoelectric polymer can more uniformly stretched, for example, a cylindrical shape.

The molded body obtained from the method for molding of the present invention can have high transparency.

The molded body obtained from the method for molding of the present invention has a piezoelectric property and can be formed into any shape. Therefore, the molded body obtained from the method for molding of the present invention can be used in a piezoelectric speaker, an actuator, a vibration generator, and haptics, or the like.

The second aspect of the present invention provides a vibration generator comprising a piezoelectric portion formed from a piezoelectric polymer; a first electrode disposed on a first main surface of the piezoelectric portion; and a second electrode disposed on a second main surface of the piezoelectric portion, which has a piezoelectric modulus of 0.5 pC/N or more and satisfies at least one of the following (a) to (c):

(a) the ratio of the length in the longitudinal direction to the thickness of the piezoelectric portion is about 100 or more;

(b) the ratio of the curvature radius of a curved portion to the thickness of the piezoelectric portion is about 10 or more; and

(c) the ratio of the length in the longitudinal direction to the curvature radius of the curved portion of the piezoelectric portion is about 0.01 or more.

The piezoelectric modulus of the piezoelectric portion is 0.5 pC/N or more, preferably 2 pC/N or more, more preferably 3 pC/N or more, further preferably 5 pC/N or more.

The ratio of the length in the longitudinal direction to the thickness of the piezoelectric portion is about 100 or more, preferably about 1,000 or more. By setting this ratio to about 100 or more, vibration due to buckling can be generated.

The ratio of the curvature radius of the curved portion to the thickness of the piezoelectric portion is about 10 or more, preferably about 30 or more, more preferably 50 or more, further preferably 100 or more. By setting this ratio to about 10 or more, vibration due to buckling can be generated.

The ratio of the length in the longitudinal direction to the curvature radius of the curved portion of the piezoelectric portion is about 0.01 or more, preferably about 0.1 or more, more preferably about 1 or more. By setting this ratio to about 0.01 or more, vibration due to buckling can be generated.

Although at least one of the conditions (a) to (c) only has to be satisfied in the present invention, it is preferable to satisfy two of the conditions at the same time and it is more preferable to satisfy all the three conditions. It is preferable to satisfy at least the condition (b) and, for example, it is preferable to satisfy only the condition (b), the conditions (a) and (b), the conditions (b) and (c), or all the conditions (a) to (c).

In the piezoelectric portion, the piezoelectric polymer is preferably oriented in the longitudinal direction of the piezoelectric portion.

The “buckling” means a phenomenon that deflection is generated by a stress from stretching of the piezoelectric polymer in the orientation direction due to shear deformation. The vibration attributable to this deformation (deflection) is referred to as the vibration due to buckling.

According the third aspect of the present invention there is provided a speaker comprising the vibration generator of the present invention as a diaphragm.

The speaker of the present invention is preferably a speaker comprising a piezoelectric portion formed from a piezoelectric polymer, a first electrode disposed on a first main surface of the piezoelectric portion, and a second electrode disposed on a second main surface of the piezoelectric portion, wherein in the piezoelectric portion

(i) the piezoelectric modulus is 2 pC/N or more,

(ii) at least a portion is curved, and

(iii) the elastic modulus is 0.1 GPa or more, and

(iv) satisfying at least one of the following (a′) to (c′) :
(a′) the ratio of the length in the longitudinal direction to the thickness of the piezoelectric portion is about 100 or more;
(b′) the ratio of the curvature radius of a curved portion to the thickness of the piezoelectric portion is about 10 or more; and
(c′) the ratio of the length in the longitudinal direction to the curvature radius of the curved portion of the piezoelectric portion is about 0.01 or more.

Although at least one of the conditions (a′) to (c′) only has to be satisfied in the present invention, it is preferable to satisfy two of the conditions at the same time and it is more preferable to satisfy all the three conditions. It is preferable to satisfy at least the condition (b′) and, for example, it is preferable to satisfy only the condition (b′), the conditions (a′) and (b′), the conditions (b′) and (c′), or all the conditions (a′) to (c′).

The speaker of the present invention will hereinafter be described in detail with reference to the drawings.

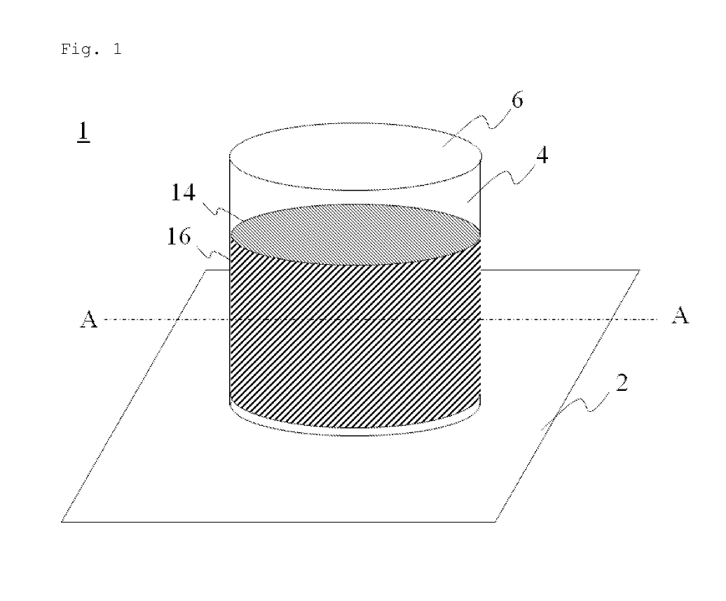

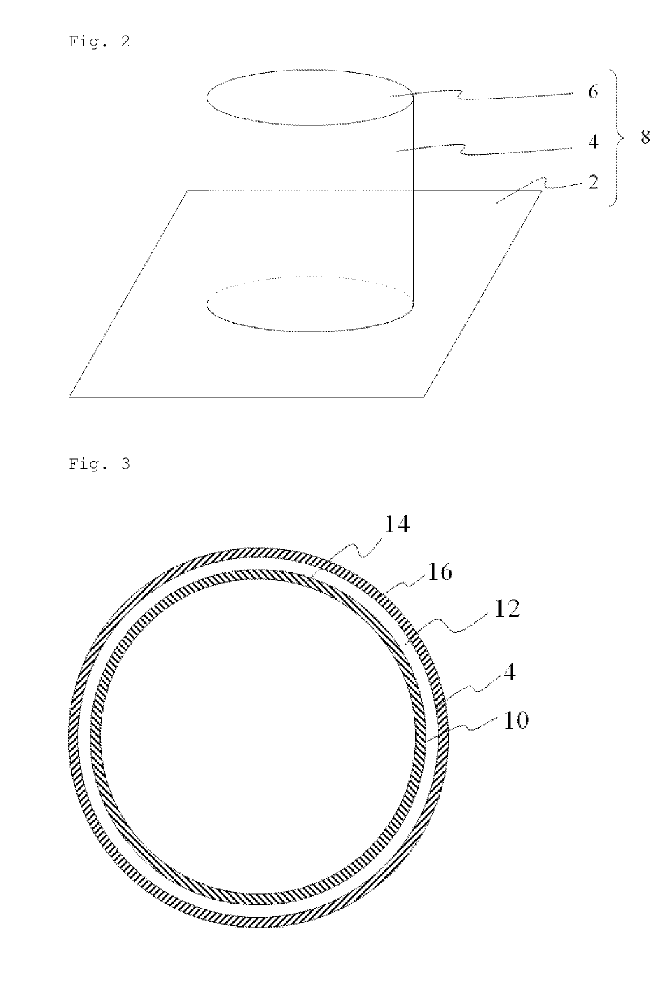

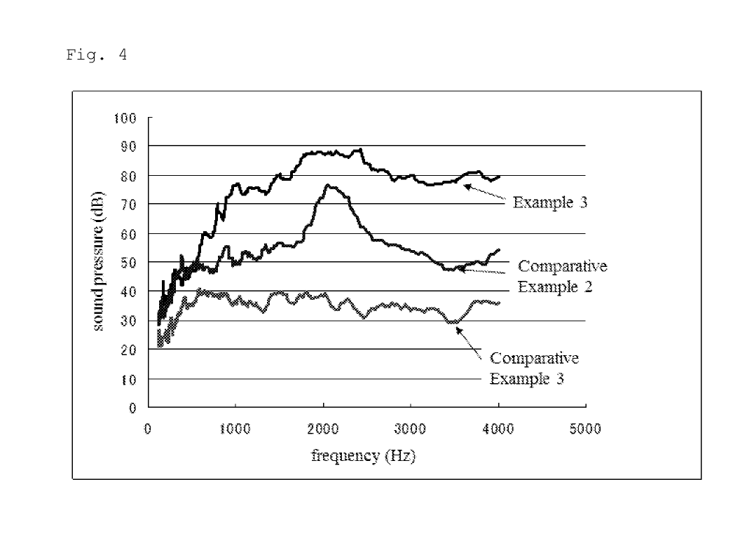

A speaker 1 of this embodiment is shown in FIG. 1, a perspective view of a body portion 8 thereof is shown in FIG. 2, and a cross-sectional view of a side surface portion 4 thereof taken along a line A-A is depicted in FIG. 3. In FIG. 3, a first electrode 14 and a second electrode 16 are schematically depicted by emphasizing the thickness although the electrodes may actually be thin layers.

As illustrated in FIGS. 1 and 2, the speaker 1 has a body portion 8 integrally formed from a bottom surface portion 2 with a circular opening portion, a cylindrical side surface portion 4 extending from the opening portion of the bottom surface portion 2 substantially perpendicular to the bottom surface portion 2, and an upper surface portion 6 closing an upper opening portion present at an upper terminal of the side surface portion 4. As illustrated in FIG. 3, an inner surface 10 and an outer surface 12 of the side surface portion 4 have the first electrode 14 and the second electrode 16, respectively.

In the speaker, the body portion 8 is made of a film formed from a piezoelectric polymer. The piezoelectric polymer is not particularly limited but may be preferably a piezoelectric polymer having helical chirality usable in the method for molding of the present invention, more preferably polylactic acid or a copolymer containing lactic acid as a constituent unit, further preferably polylactic acid.

The film may contain additives such as a softening agent, a coloring agent, and a plasticizing agent.

The side surface portion 4 has a piezoelectric property and a voltage is applied via the first electrode 14 and the second electrode 16 disposed on the both main surfaces (i.e., the inner surface 10 and the outer surface 12). By changing this voltage, the side surface portion 4 vibrates and generates a sound wave. Therefore, the side surface portion 4 acts as a diaphragm.

The side surface portion 4 corresponds to the “piezoelectric portion” of the speaker of the present invention and preferably satisfies at least one of the following four features:

(i) having the piezoelectric modulus of about 2 pC/N or more;

(ii) having at least a portion that is curved;

(iii) having the elastic modulus of about 0.1 GPa or more; and

(iv) satisfying at least one of the following (a″) to (c″):
(a″) the ratio of the length in the longitudinal direction (the height direction of a cylinder) to the thickness is about 100 or more;
(b″) the ratio of the radius of the cylinder to the thickness is about 10 or more; and
(c″) the ratio of the length in the longitudinal direction to the radius of the cylinder is about 0.01 or more.

The feature (i) will hereinafter be described.

In the side surface portion 4 in this embodiment, the piezoelectric polymer having helical chirality in form of a film is uniaxially oriented in the height direction of the cylinder and this gives a piezoelectric property to the side surface portion 4. Because of the piezoelectric property, deformation (shear deformation) occurs in the film when a voltage is applied between the both main surfaces of the side surface portion 4. By changing this voltage, the side surface portion vibrates.

In the present invention, the piezoelectric modulus of the piezoelectric portion may be a piezoelectric modulus sufficient for deforming the piezoelectric portion by the application of voltage, but is, for example, about 2 pC/N or more, preferably about 3 pC/N or more, more preferably about 4 pC/N or more, further preferably about 6 pC/N or more, particularly preferably about 8 pC/N or more.

The feature (ii) will be described.

The side surface portion 4 of this embodiment is curved due to being formed into a substantially cylindrical shape. Because of this curve, the vibration (shear deformation) parallel to a film plane occurring on the piezoelectric polymer film can make an appearance on the surface of the film. The vibration appearing on the surface in this way vibrates the surrounding air and generates a sound wave.

In this embodiment, the radius of the cylinder of the side surface portion 4 is not particularly limited. When the radius is made smaller, a degree of the curve becomes larger and the vibration generated by the shear deformation can more efficiently appear on the surface of the film, resulting in a larger sound pressure per unit area. On the other hand, when the radius is made larger, the vibration generated by the shear deformation appears on the surface of the film at a lower efficiency; however, the surface area of the side surface portion, i.e., the surface area of the diaphragm is made larger. Therefore, the radius is determined in consideration of an overall sound pressure and, for example, in this embodiment, the radius of the cylinder of the side surface portion 4 can be about 0.3 to 20 cm, preferably about 1 to 10 cm.

It is noted that although the side surface portion 4 is in a cylindrical shape in this embodiment, the present invention is not limited to this form and at least a portion of the piezoelectric portion may be curved such that the vibration generated by the shear deformation can appear on the surface of the piezoelectric portion. For example, the curved portion of the piezoelectric portion may have, but not limited to, a curvature radius of about 0.05 to 100 cm, for example, about 1 to 20 cm.

The feature (iii) will be described.

In this embodiment, the side surface portion 4 has an elastic modulus of about 0.1 GPa or more, preferably about 0.3 GPa or more, more preferably about 0.5 GPa or more, further preferably 1 GPa or more, particularly preferably 1.5 GPa or more. The side surface portion 4 having an elastic modulus of about 0.1 GPa or more can more strongly vibrate the surrounding air. As a result, a high sound pressure can be achieved.

The feature (iv) will be described.

In this embodiment, the side surface portion 4 satisfies at least one of the following (a″) to (c″):

(a″) the ratio of the length in the longitudinal direction (the height direction of the cylinder) to the thickness is about 100 or more;

(b″) the ratio of the radius of the cylinder to the thickness is about 10 or more; and

(c″) the ratio of the length in the longitudinal direction to the radius of the cylinder is about 0.01 or more.

The ratio of the length in the longitudinal direction (the height direction of the cylinder) to the thickness is about 100 or more, preferably about 1,000 or more.

The ratio of the curvature radius of the radius of the cylinder to the thickness is about 10 or more, preferably about 30 or more, more preferably 50 or more, further preferably 100 or more.

The ratio of the length in the longitudinal direction to the radius of the cylinder is about 0.01 or more, preferably about 0.1 or more, more preferably 1 or more.

By satisfying at least one of the conditions (a″) to (c″), the side surface portion 4 can generate the vibration due to buckling. By generating the vibration due to buckling in this way, flat sound pressure-frequency characteristics can be achieved over a wide frequency region.

The length in the longitudinal direction of the side surface portion 4 is not particularly limited and is about 0.5 to 100 cm, preferably about 1 to 50 cm, more preferably about 5 to 30 cm.

The radius of the side surface portion 4 is not particularly limited but is about 0.5 to 30 cm, preferably about 1 to 20 cm, more preferably about 2 to 10 cm.

The film thickness of the side surface portion 4 is not particularly limited but is about 1 μm to 50 mm, preferably about 0.01 to 10 mm, more preferably about 0.1 to 1 mm, further preferably about 0.1 to 0.3 mm.

The piezoelectric portion of the side surface portion 4 preferably has retardation of 100 nm or more, more preferably 500 nm or more, further preferably 1,000 nm or more.

The speaker of the present invention utilizes the vibration due to buckling to improve the sound pressure and the sound pressure-frequency characteristics. Therefore, by facilitating the generation of the vibration due to buckling, the speaker of the present invention can further improve the sound pressure and the sound pressure-frequency characteristics.

Methods of facilitating the generation of the vibration due to buckling include, for example, applying a stress to the piezoelectric portion. The stress is preferably applied in the longitudinal direction of the piezoelectric portion, or in this embodiment, in the height direction of the cylinder.

In this embodiment, the side surface portion 4 has the first electrode 14 and the second electrode 16 on the inner surface 10 and the outer surface 12, respectively. Between the first electrode 14 and the second electrode 16, a voltage is applied to the side surface portion 4 having the piezoelectric property.

A conductive material forming the first electrode and the second electrode is not particularly limited but may be Cu, Ag, or Ni, for example. A method of forming the electrodes is not particularly limited but may be a vapor deposition method, for example.

The first electrode and the second electrode may entirely or only partially be formed on the respective main surfaces of the piezoelectric portion.

Although the bottom surface portion 2 and the upper surface portion 6 do not particularly need to have a piezoelectric property and do not generate vibration by themselves, the bottom surface portion 2 and the upper surface portion 6 fix the lower end and the upper end, respectively, of the side surface portion 4, stabilize the vibration generated in the side surface portion 4, and improve the strength of the vibration, thereby contributing to the improvement in sound pressure and sound quality. When a frequency region with a relatively low sound pressure is present as compared to the other frequency regions, the bottom surface portion 2 or the upper surface portion 6 can be in a form of causing resonance in the frequency region so as to improve the sound pressure, thereby providing flatter sound pressure-frequency characteristics.

A method of manufacturing the speaker 1 of this embodiment will be described.

The body portion 8 of the speaker in this embodiment can simply be manufactured by the method for molding of the present invention described above. In particular, a film formed from a piezoelectric polymer is molded into the shape of the body portion 8 by vacuum molding at a temperature not less than the glass transition temperature and less than the crystallization temperature of the piezoelectric polymer and is then heat-treated at a temperature not less than the crystallization temperature of the piezoelectric polymer, thereby manufacturing the body portion 8.

Subsequently, conductive metal is vapor-deposited on the inner surface and the outer surface of the side surface portion 4 to form the first electrode and the second electrode, thereby obtaining the speaker 1 of this embodiment.

Although one embodiment of the present invention has been described, the present invention is not limited to this embodiment.

Particularly, the speaker of the present invention can be produced by using the method for molding of the present invention described above and can therefore be formed into any shapes that can be produced by the method for molding of the present invention. Thus, by using the method for molding of the present invention, a piezoelectric polymer can be molded into, for example, a frame of television, a housing of a portable telephone or a portable game machine, or a portion thereof and a piezoelectric property can be given thereto to impart a function as a speaker thereto.

### EXAMPLES

Although the present invention will more specifically be described in the following examples, the present invention is not limited to these examples.

### Example 1

A polylactic acid film (in a sheet shape with a molecular weight of 100,000 and a thickness of 1 mm manufactured by Taki Chemical Co., Ltd.) was set in a vacuum molding machine. A metal mold having a radius of 5 cm and a depth of 12 cm was used. The film was heated to 99.3° C. and vacuum-molded while the film is pushed in from the upper surface thereof toward the metal mold by a plug with a pressure of about 2 tons. An obtained molded body was taken out from the vacuum molding machine, was fixed to a jig corresponding to the shape of the molded body, was heat-treated in a heating furnace at about 110° C. for 5 minutes, and was subsequently rapidly cooled in a water tank filled with water to obtain a molded body corresponding to FIG. 2 having a radius of 5 cm and a height of 12 cm as dimensions of a cylindrical portion.

### Example 2

A molded body was obtained in the same way as Example 1 except that the polylactic film used in Example 1 was changed to a polylactic acid film with a molecular weight of 60,000 and a thickness of 0.5 mm (manufactured by Taki Chemical Co., Ltd).

### Comparative Example 1

A molded body was obtained in the same way as Example 1 except that the vacuum molding was performed at the film temperature of 110° C. without pushing-in by the plug.

### Experimental Example 1

Samples with a length of 120 mm and a width of 5 mm were cut out from the cylindrical portions of the molded bodies of Examples 1 and 2, and Comparative Example 1. The piezoelectric modulus and the retardation were measured in upper, middle and lower portions obtained by horizontally equally dividing each of the samples into three pieces (the upper side of FIG. 2 corresponds to the upper portion). The results are described in Table 1.

TABLE 1

| | | piezoelectric | retardation |
|---|---|---|---|
| | | modulus (pC/N) | (nm) |
| Example 1 | upper portion | 3.85 | 2202.2 |
| | middle portion | 5.25 | 2542.6 |
| | lower portion | 4.75 | 2347.8 |
| Example 2 | upper portion | 3.45 | 1000.2 |
| | middle portion | 5.05 | 1892.6 |
| | lower portion | 4.55 | 1267.8 |
| Comparative | upper portion | 0.08 | 40.2 |
| Example 1 | middle portion | 0.05 | 50.6 |
| | lower portion | 0.09 | 70.8 |

As shown in Table 1, it is confirmed that a molded body with high piezoelectric modulus and retardation can be obtained by using the method for molding of the present invention.

### Example 3

A molded body was obtained in the same way as Example 1 except that the polylactic film used in Example 1 was changed to a polylactic acid film with a molecular weight of 90,000 and a thickness of 0.1 mm (manufactured by Taki Chemical Co., Ltd). Electrodes were formed by vapor deposition of copper on both main surfaces of a side surface portion of the obtained molded body to fabricate a speaker of the present invention.

### Comparative Example 2

A molded body was obtained in the same way as Example 1 except that the polylactic film used in Example 1 was changed to a polylactic acid film with a molecular weight of 60,000 and a thickness of 1.5 mm (manufactured by Taki Chemical Co., Ltd). Electrodes were formed by vapor deposition of copper on both main surfaces of a side surface portion of the obtained molded body to fabricate a speaker of Comparative Example 2.

### Comparative Example 3

A molded body was obtained in the same way as Example 1 except that the vacuum molding was performed at the film temperature of 110° C. without pushing-in by the plug. Electrodes were formed by vapor deposition of copper on both main surfaces of a side surface portion of the obtained molded body to fabricate a speaker of Comparative Example 3.

The dimensions of the cylindrical portions of Example 3 and Comparative Examples 2 and 3 are described in Table 2. The film thickness is a value at the middle portion of the cylinder.

TABLE 2

| | | | film | | | | |
|---|---|---|---|---|---|---|---|
| | | | thick- | piezo- | | | |
| | height | radius | ness | electric | | | |
| | (h) | (r) | (d) | modulus | | | |
| | (cm) | (cm) | (mm) | (pC/N) | h/d | r/d | h/r |
| Example 3 | 12 | 5 | 0.1 | 5.0 | 1200 | 500 | 2.4 |
| Comparative | 30 | 1 | 1.2 | 2.5 | 250 | 8.3 | 30 |
| Example 2 | | | | | | | |
| Comparative | 12 | 5 | 0.1 | 0.1 | 1200 | 500 | 2.4 |
| Example 3 | | | | | | | |

### Experimental Example 2

The sound pressure-frequency characteristics were measured in Example 3 and Comparative Examples 1 and 2 by using an acoustic measurement apparatus (LA2560, Ono Sokki). The results are depicted in FIG. 4.

As apparent from FIG. 4, the speaker of Comparative Example 3 with the piezoelectric modulus of less than 1 pC/N (0.1 pC/N) has the sound pressure below 40 dB in the almost entire frequency region, which is insufficient for use as a speaker.

Comparative Example 2 with r/d of less than 10 (8.3) has a large sound pressure peak in the frequency of 1,500 to 2,500 Hz and has a large difference of about 30 dB between the sound pressure around the frequency of 1,000 Hz and the sound pressure around the frequency of 2,000 Hz. It is considered that this peak is attributable to resonance.

On the other hand, the speaker of Example 3 has the sound pressure increased even in the regions other than around the resonance frequency, generally has the sound pressure of 70 dB or more, and has the difference suppressed to about 10 dB between the sound pressure around the frequency of 1,000 Hz and the sound pressure around the frequency of 2,000 Hz, and it is confirmed that favorable sound pressure-frequency characteristics can be obtained as a whole. It is considered that this is because the vibration due to buckling enables the acquisition of high sound pressure even in the frequency regions other than the resonance frequency.

### INDUSTRIAL APPLICABILITY

The method for molding of the present invention enables the formation of molded bodies of piezoelectric materials in various shaped and such molded bodies may widely be used as speakers, actuations, etc. in various applications.

### EXPLANTATION OF THE REFERENCE NUMERALS

1 speaker
2 bottom surface portion
4 side surface portion
6 upper surface portion
8 body portion
10 inner side surface
12 outer side surface
14 first electrode
16 second electrode

The present invention provides the following embodiments:
1. A method for molding a piezoelectric polymer, wherein a material formed from a piezoelectric polymer is molded at a temperature not less than the glass transition temperature and less than the crystallization temperature of the piezoelectric polymer and is then heat-treated at a temperature not less than the crystallization temperature of the piezoelectric polymer.
2. The method for molding according to embodiment 1, wherein the molding is performed by using a vacuum molding method.
3. The method for molding according to embodiment 2, wherein the vacuum molding is performed while the material formed from a piezoelectric polymer is being pushed in by an auxiliary plug.
4. The method for molding according to any one of embodiments 1 to 3, wherein the piezoelectric polymer is polylactic acid or a copolymer containing lactic acid as a constituent unit.
5. The method according to any one of embodiments 1 to 4, wherein the molding temperature is about 50 to 105° C.
6. The method according to any one of embodiments 1 to 5, wherein the temperature of the heat treatment is not less than the crystallization temperature and not more than the melting point of the piezoelectric polymer.
7. The method according to any one of embodiments 1 to 6, wherein the temperature of the heat treatment is about 80 to 150° C.
8. The method for molding according to any one of embodiments 1 to 7, wherein the material formed from a piezoelectric polymer contains a softening agent.
9. The method for molding according to embodiment 8, wherein the softening agent is a PMMA-PnBA-PMMA block copolymer.
10. A molded body obtained by using the method for molding according to any one of embodiments 1 to 9.
11. The molded body according to embodiment 10, comprising a substantially cylindrical portion.
12. A vibration generator comprising a piezoelectric portion formed from a piezoelectric polymer; a first electrode disposed on a first main surface of the piezoelectric portion; and a second electrode disposed on a second main surface of the piezoelectric portion, which has a piezoelectric modulus of 0.5 pC/N or more and satisfies at least one of the following (a) to (c):

(a) the ratio of the length in the longitudinal direction to the thickness of the piezoelectric portion is about 100 or more;

(b) the ratio of the curvature radius of a curved portion to the thickness of the piezoelectric portion is about 10 or more; and

(c) the ratio of the length in the longitudinal direction to the curvature radius of the curved portion of the piezoelectric portion is about 0.01 or more.
13. A speaker comprising the vibration generator according to embodiment 12 as a diaphragm.
14. The speaker according to embodiment 13, wherein the piezoelectric modulus is 2 pC/N or more, at least a portion is curved, and the elastic modulus is 0.1 GPa or more in the piezoelectric portion of the diaphragm.
15. The speaker according to embodiment 13 or 14, wherein the piezoelectric modulus is about 3.5 pC/N or more, the elastic modulus is about 1 GPa or more, and the ratio in the longitudinal direction to the thickness is about 100 or more in the piezoelectric portion of the diaphragm.
16. The speaker according to any one of embodiments 13 to 15, wherein the piezoelectric polymer is a polymer containing polylactic acid.
17. The speaker according to any one of embodiments 13 to 16, wherein the piezoelectric portion has a substantially cylindrical shape.
18. The vibration generator according to embodiment 12 or the speaker of any one of embodiments 13 to 17 produced by using the method for molding of any one of embodiments 1 to 9.

1. A method for molding a piezoelectric polymer, wherein a material formed from a piezoelectric polymer is molded by using a vacuum molding method at a temperature not less than the glass transition temperature and less than the crystallization temperature of the piezoelectric polymer and is then heat-treated at a temperature not less than the crystallization temperature of the piezoelectric polymer.

2. (canceled)

3. The method for molding according to claim 1, wherein the vacuum molding is performed while the material formed from a piezoelectric polymer is being pushed in by an auxiliary plug.

4. The method for molding according to claim 1, wherein the piezoelectric polymer is polylactic acid or a copolymer containing lactic acid as a constituent unit.

5. The method according to claim 1, wherein the molding temperature is about 50 to 105° C.

6. The method according to claim 1, wherein the temperature of the heat treatment is not less than the crystallization temperature and not more than the melting point of the piezoelectric polymer.

7. The method according to claim 1, wherein the temperature of the heat treatment is about 80 to 150° C.

8. The method for molding according to claim 1, wherein the material formed from a piezoelectric polymer contains a softening agent.

9. The method for molding according to claim 8, wherein the softening agent is a PMMA-PnBA-PMMA block copolymer.

10. A molded body obtained by using the method for molding according to claim 1.

11. The molded body according to claim 10, comprising a substantially cylindrical portion.

12. A vibration generator comprising a piezoelectric portion formed from a piezoelectric polymer; a first electrode disposed on a first main surface of the piezoelectric portion; and a second electrode disposed on a second main surface of the piezoelectric portion wherein the piezoelectric polymer is oriented in the longitudinal direction of the piezoelectric portion and the piezoelectric portion has a curved portion, which has a piezoelectric modulus of 0.5 pC/N or more and satisfies at least one of the following (b):
(b) the ratio of the curvature radius of a curved portion to the thickness of the piezoelectric portion is about 10 or more;

13.-18. (canceled)

19. The vibration generator according to claim 12 which satisfies at least one of the following (a) and (c):
(a) the ratio of the length in the longitudinal direction to the thickness of the piezoelectric portion is about 100 or more; or
(b) the ratio of the curvature radius of a curved portion to the thickness of the piezoelectric portion is about 10 or more; and
(c) the ratio of the length in the longitudinal direction to the curvature radius of the curved portion of the piezoelectric portion is about 0.01 or more.

20. A speaker comprising the vibration generator according to claim 12 as a diaphragm.

21. The speaker according to claim 20, wherein the piezoelectric modulus is 2 pC/N or more, at least a portion is curved, and the elastic modulus is 0.1 GPa or more in the piezoelectric portion of the diaphragm.

22. The speaker according to claim 20, wherein the piezoelectric modulus is about 3.5 pC/N or more, the elastic modulus is about 1 GPa or more, and the ratio in the longitudinal direction to the thickness is about 100 or more in the piezoelectric portion of the diaphragm.

23. The speaker according to claim 20, wherein the piezoelectric polymer is a polymer containing polylactic acid.

24. The speaker according to claim 20, wherein the piezoelectric portion has a substantially cylindrical shape.

25. The vibration generator according to claim 12 produced by using a method for molding a piezoelectric polymer, wherein a material formed from a piezoelectric polymer is molded by using a vacuum molding method at a temperature not less than the glass transition temperature and less than the crystallization temperature of the piezoelectric polymer and is then heat-treated at a temperature not less than the crystallization temperature of the piezoelectric polymer.

26. The speaker of claim 20 produced by using a method for molding a piezoelectric polymer, wherein a material formed from a piezoelectric polymer is molded by using a vacuum molding method at a temperature not less than the glass transition temperature and less than the crystallization temperature of the piezoelectric polymer and is then heat-treated at a temperature not less than the crystallization temperature of the piezoelectric polymer.
